(19) United States
(12) Patent Application Publication
(10) Pub. No.: US 2021/0285245 A1
(43) Pub. Date: Sep. 16, 2021

(54) Polygonal Communities

(71) Applicant: Kristian R. Reynolds, Greeley, CO (US)

(72) Inventor: Kristian R. Reynolds, Greeley, CO (US)

(21) Appl. No.: 17/199,104

(22) Filed: Mar. 11, 2021

Related U.S. Application Data
(60) Provisional application No. 62/988,081, filed on Mar. 11, 2020.

(51) Int. Cl. E04H 1/00; G06Q 50/26

(52) U.S. Cl. CPC E04H 1/005; G06Q 50/26

(57) ABSTRACT

A neighborhood is formed of polygonal communities adjacent to each other. Each polygonal community includes dwellings arrayed inside a periphery of the polygon and a shared central space between the dwellings. The polygonal communities may be hexagonal. Often, each polygonal community uses the shared central space between the houses for shared assets like an energy generating and distribution system or a leach field for a shared septic system. Utilities may be provided to each dwelling within a community in a hub and spoke configuration or via a distribution system having a channel running around inside the polygon periphery.

### BACKGROUND OF THE INVENTION

### Field of the Invention

The present invention relates to neighborhoods formed of adjacent polygonal communities.

### Discussion of Related Art

Currently, communities are generally organized in regular grids or approximations of grids. This provides easy road access and individual private back yards. It is not efficient in the use of land and utility lines.

### SUMMARY OF THE INVENTION

The present invention is directed to communities organized for affordability and efficiency, specifically communities organized in regular polygons, generally with shared back yards. The typical polygon would comprise one acre, since that is what most municipalities use, but other sizes are also possible.

One example that works well is a community formed of hexagonal polygons, as these are efficient in their use of land, roads, and utilities. in addition, these hexagons fit together well with no wasted space.
Communities will generally share what would otherwise be backyards. These shared central spaces allow for a number of efficiencies, as well as providing a community gathering place and a location for various shared assets, such as a common septic system, energy collection, parks, water retention areas, community gardens, business facilities, etc.
The polygonal communities may comprise single family homes, multifamily homes such as duplexes, and can be made from various building codes such as but not limited to IRC, UBC, HUD, RV
The polygonal communities may include their own water collection and/or filtration systems, or connect to a municipal water system. The water pipes may run along the polygon perimeters or form a hub and spoke configuration.
The polygonal communities may include a common septic system and leach field in the shared central area. Or the communities may connect to a municipal sewer system.
The communities may include a common energy system (e.g., solar panels, wind turbines, geothermal system) and/or be connected to the grid.
Other utilities (e.g. telecommunication, fiber optics, gas, air pollution filtration) may be shared or delivered traditionally.
Other aspects of a community (roads, landscaping, bike paths, sidewalks, curb and gutters, crosswalks, yield signs, stop sighs, stoplights, roundabouts, retainer walls, tunnels, bridges, bunkers, community centers, parks, gardens, shops, commercial space, open space, lakes, water retention areas) also allow for efficiency.

### BRIEF DESCRIPTION OF THE DRAWINGS

FIG. 1 is a top view of four joined hexagonal communities including a sewer mainline.

FIG. 2 is a top view of the four joined hexagonal communities of FIG. 1 showing sewer distribution among the houses.

FIG. 3 is a top view of four joined hexagonal communities showing a water system which runs along the perimeters of the polygons.

FIG. 4 is a top view of four joined hexagonal communities showing an expanded section.

FIG. 5 is a top view of the four joined hexagonal communities of FIG. 1 showing wells and septic lines to a community leach field.

FIG. 6 is a top view of the four joined hexagonal communities of FIG. 1 showing electrical and telecom distribution.

FIG. 7 is a top view of the four joined hexagonal communities of FIG. 1 showing gas distribution.

FIG. 8 is an isometric view of the four joined hexagonal communities of FIG. 1.

FIG. 9 is a top view of the four joined hexagonal communities of FIG. 1 with a sectional view through three hexagonal communities.

FIG. 10 is a top view of the four joined hexagonal communities of FIG. 1 with a sectional view through one hexagonal community.

FIG. 11 is an isometric view of a first configuration of four octagonal communities.

FIG. 12 is an isometric view of a second configuration of four octagonal communities.

### DETAILED DESCRIPTION OF THE INVENTION

TABLE 1

| Ref. No. | Element |
|---|---|
| 1, 7 | Roads |
| 2 | Houses |
| 3 | Sewer mainline |
| 4, 8 | Driveways |
| 5 | Sewer distribution |
| 6 | Water lines |
| 9 | Sidewalks |
| 10 | Well |
| 11 | Septic line to central tank |
| 12 | Electrical system |
| 13 | Telecom/Fiberoptics/Cable |
| 14 | Natural gas or propane |
| 15 | Hexagonal community |
| 16 | Neighborhood of hexagonal communities |
| 17 | Shared central spaces |
| 18 | Leach field |
| 19 | Shared space by multiple communities |

Table 1 shows Invention elements and associated reference numbers.

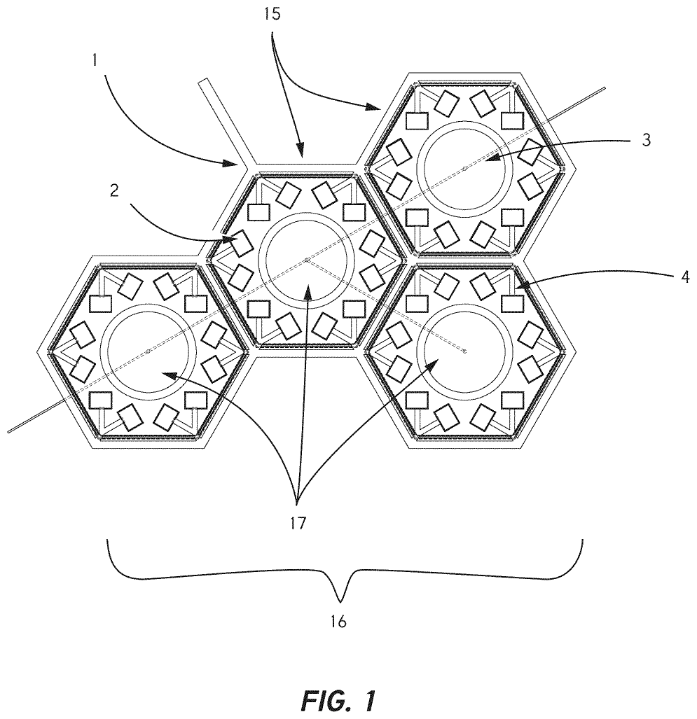

FIG. 1 is a top view of four joined hexagonal communities 15 forming a neighborhood 16. FIG. 1 shows roads 1, houses (or other dwellings) 2, a sewer mainline 3, and driveways 4. This embodiment includes 12 houses per community 15. Two houses 2 share a driveway entrance. Each community 15 includes a shared central space 17 surrounded by houses 2.

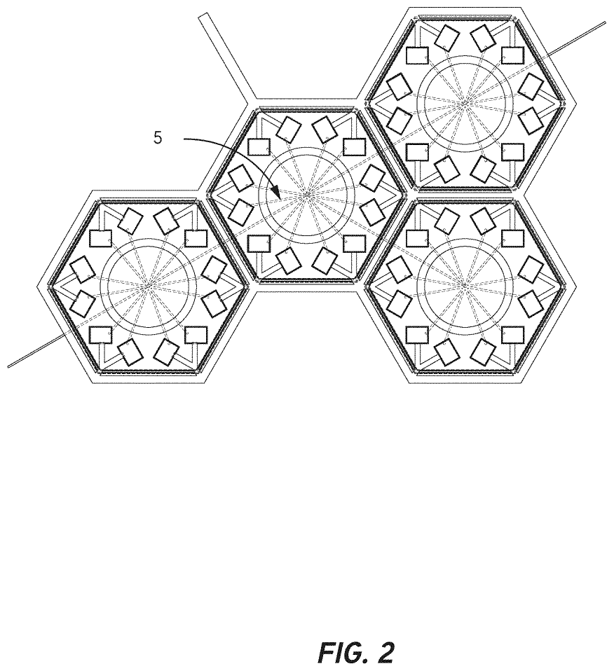

FIG. 2 is a top view of four joined hexagonal communities 15 showing sewer distribution among the houses. From mainline 3, lines 5 form a hub and spoke configuration with a line 5 to each house 2

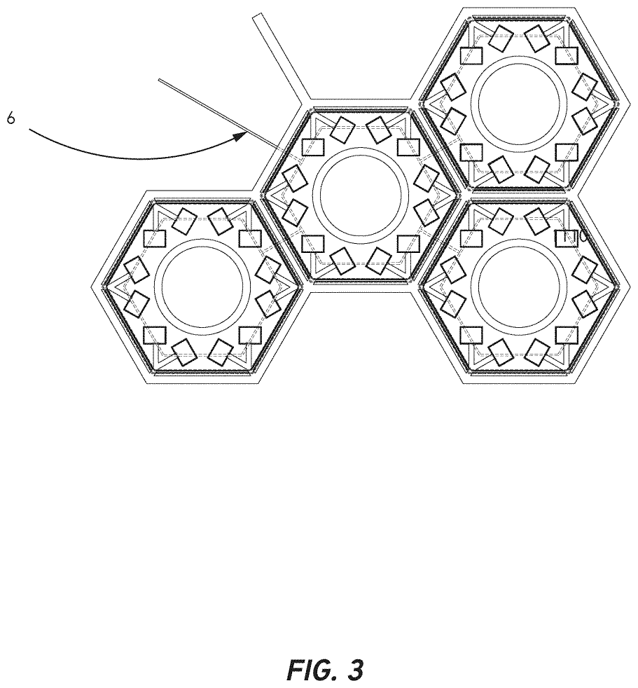

FIG. 3 is a top view of four joined hexagonal communities 15 showing a water system which runs inside the perimeters of the hexagonal communities 15, providing water to each house 2. As an alternative, the water system could be hub and spoke.

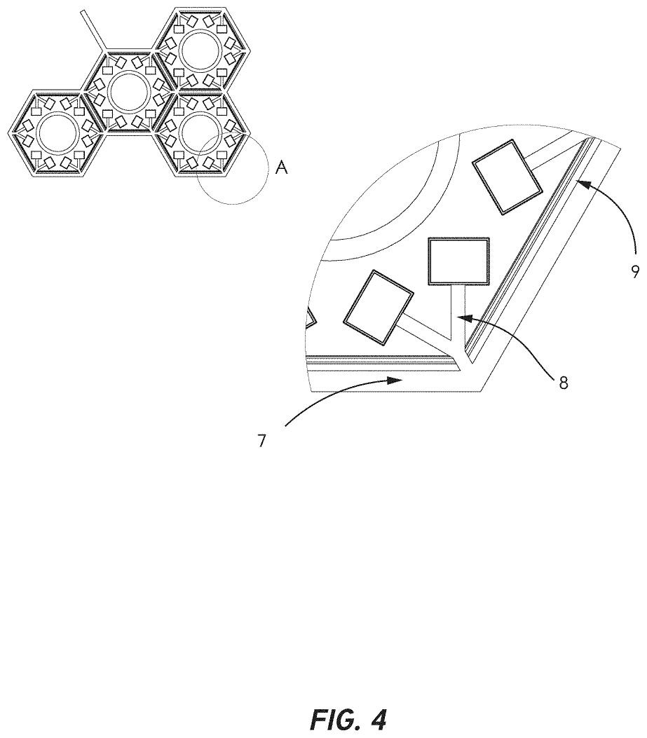

FIG. 4 is a top view of four joined hexagonal communities 15 showing an expanded section A. Roads 7, driveways 8 and sidewalks 9 are shown in detail.

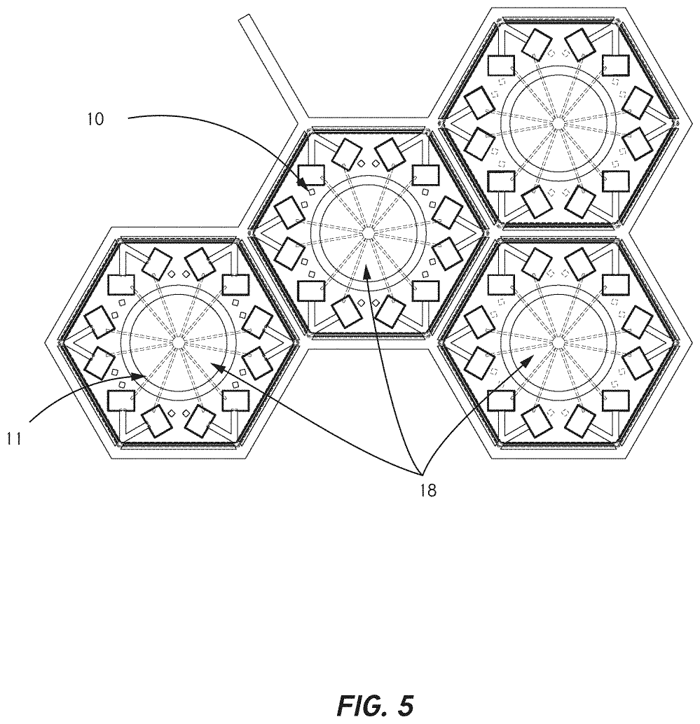

FIG. 5 is a top view of the four joined hexagonal communities 15 of FIG. 1 showing wells 10 and septic lines 11 to a community leach field 18 within shared space 17.

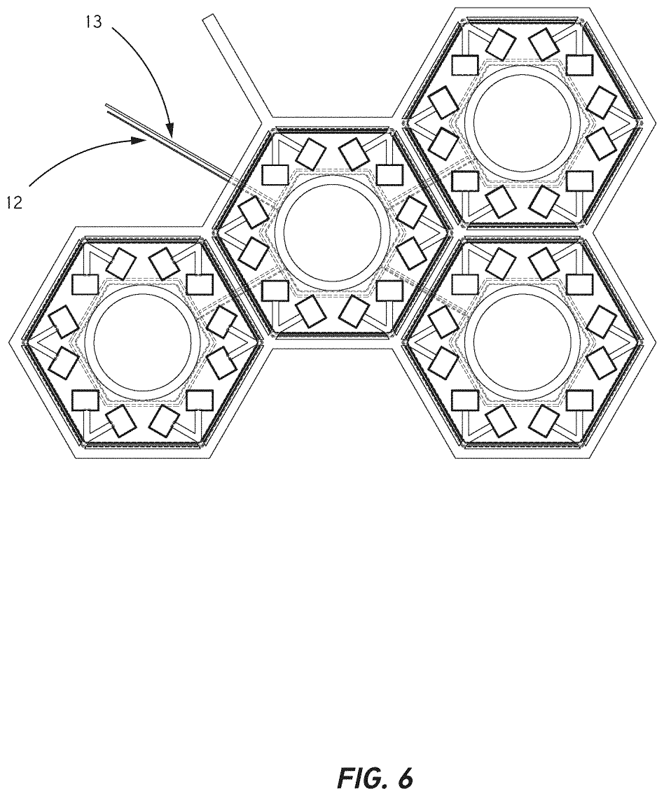

FIG. 6 is a top view four joined hexagonal communities 15 showing electrical system 12 and telecom distribution 13. Telecom 13 may comprise cable, fiber optics, etc.

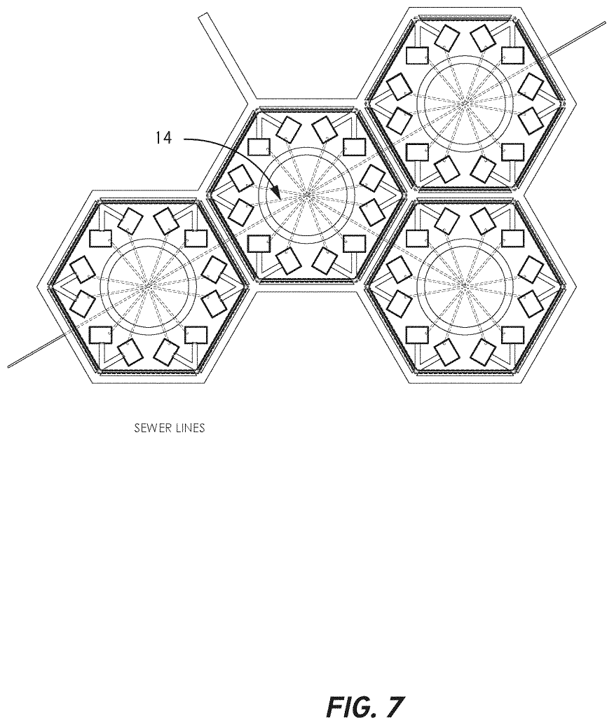

FIG. 7 is a top view of four joined hexagonal communities 15 showing gas distribution 14, in a hub and spoke configuration. Natural gas or propane may be used.

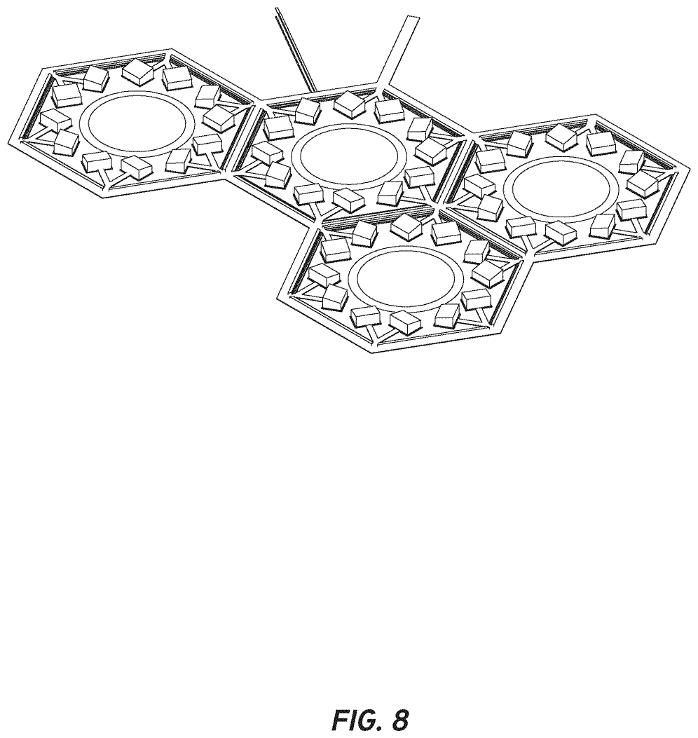

FIG. 8 is an isometric view of the four joined hexagonal communities 15 of FIG. 1.

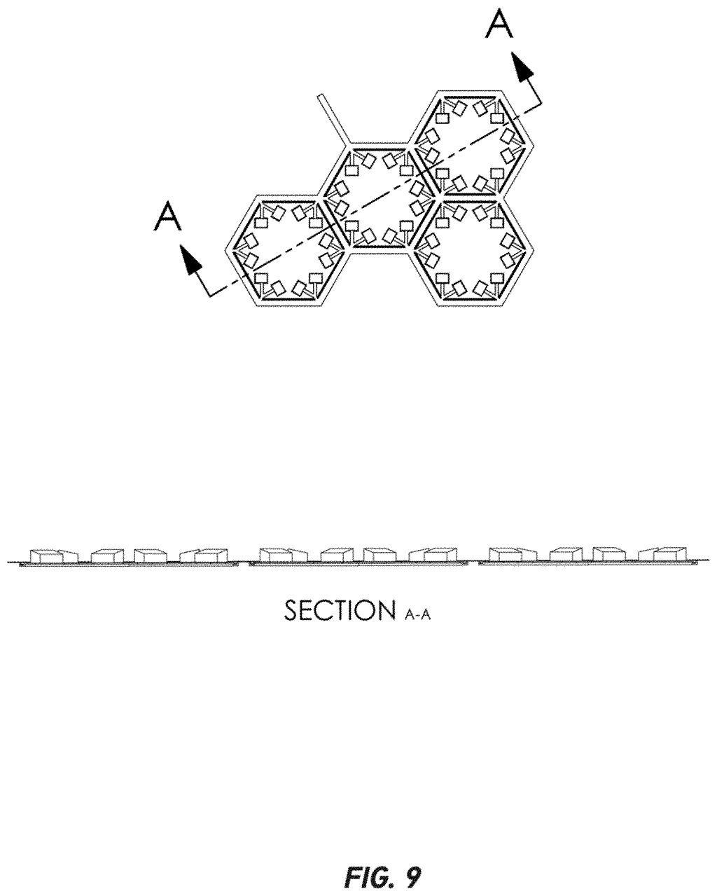

FIG. 9 is a top view of the four joined hexagonal communities 15 of FIG. 1 with a sectional view through three of the hexagonal communities.

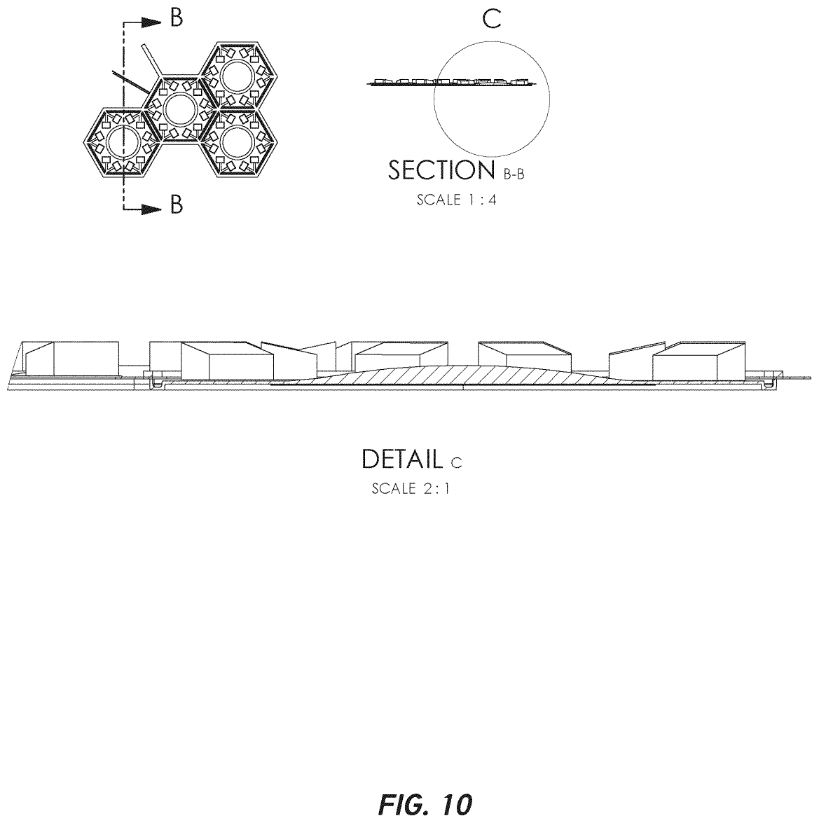

FIG. 10 is a top view of the four joined hexagonal communities 15 of FIG. 1 with a sectional view along section BB. A detailed view C is provided for details. Detail C shows the elevation change, that the center of the community were backyards are shared is higher so that water can slope towards the streets and into storm water collection and be stored for later use or distributed to the appointed water retention areas.

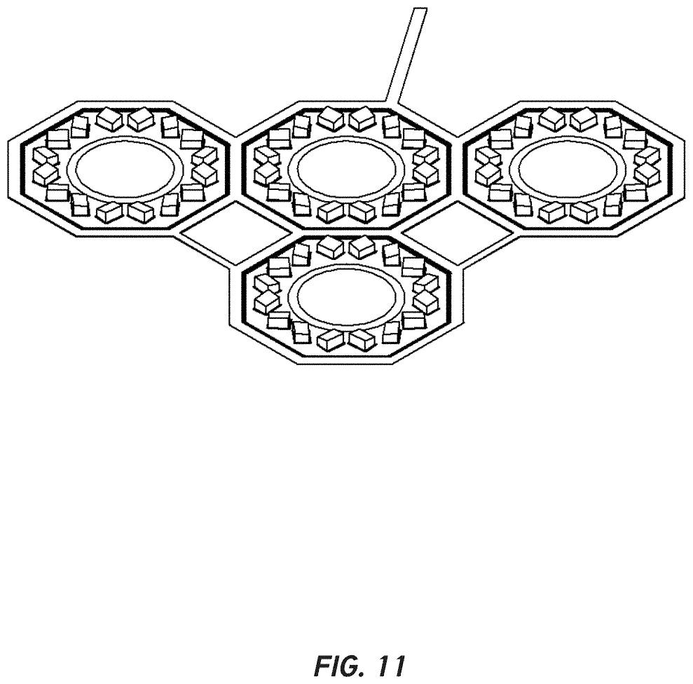

FIG. 11 is an isometric view of a first configuration of four octagonal communities. There are diamond-shaped spaces, since octagons don't fit together without leaving space like hexagons do. These spaces may be used for public areas like parks, community centers, parking, etc.

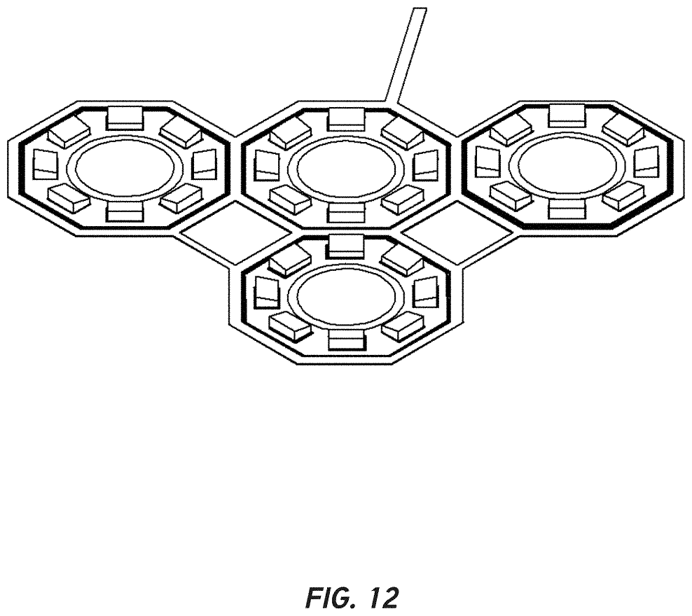

FIG. 12 is an isometric view of a second configuration of four octagonal communities. It is similar to the configuration of FIG. 11, except that 8 dwellings are included each hexagonal community.

While the exemplary preferred embodiments of the present invention are described herein with particularity, those skilled in the art will appreciate various changes, additions, and applications other than those specifically mentioned, which are within the spirit of this invention.

For example, the community polygons may be other shapes. If an octagon shape is chosen, there are several ways they can fit together efficiently. Most of the models require an additional shape to be placed where the four communities come together. This area can be used as additional parking, parks, amphitheaters, water retention areas, businesses, etc.

A retainer wall can be placed around the perimeter to elevate the community from the road. This would provide some added privacy and reduce vehicle pollution contaminates as well as noise pollution.

A storm water system was not shown here. Most municipalities will require a civil engineer to design such system based on storm water trends for that geographical area.

A community may be residential or commercial space. Each community can have separate lots within it or can be whole with shared ownership like a corporation.

What is claimed is:

1. A neighborhood comprising:
a plurality of polygonal shaped communities adjacent to each other, each polygon having at least six sides;
wherein each polygonal community includes dwellings arrayed inside a periphery of the polygonal community and a shared central space between the dwellings.

2. The neighborhood of claim 1 wherein the polygonal communities are hexagonal.

3. The neighborhood of claim 2 wherein each polygonal community further comprises shared assets within the shared central space.

4. The neighborhood of claim 2 wherein the shared asset comprises an energy generating and distribution system.

5. The neighborhood of claim 2 wherein the shared asset comprises a leach field for a shared septic system.

6. The neighborhood of claim 2 wherein a utility is distributed among the dwellings in a polygonal community via a hub and spoke distribution system having a hub in the shared central space.

7. The neighborhood of claim 6 wherein the distributed utility comprises electricity.

8. The neighborhood of claim 6 wherein the distributed utility comprises water.

9. The neighborhood of claim 6 wherein the distributed utility comprises at least one of cable, optical fiber, or satellite.

10. The neighborhood of claim 2 further comprising a sewer system connected to the dwellings in a polygonal community via a hub and spoke distribution system having a hub in the shared central space.

11. The neighborhood of claim 2 wherein a utility is distributed among the dwellings in a polygonal community via a distribution system having a channel disposed inside the polygon periphery and running around the polygon periphery.

12. The neighborhood of claim 2 wherein each hexagon is configured with its sides flush and even with a side of every adjacent polygon.

13. The neighborhood of claim 1 wherein the polygons are octagons.

14. The neighborhood of claim 1 wherein the dwellings are houses.

15. The neighborhood of claim 1 wherein each polygonal community further comprises shared assets within the shared central space.

16. The neighborhood of claim 1 wherein a utility is distributed among the dwellings in a polygonal community via a hub and spoke distribution system having a hub in the shared central space.
